(19) United States
(12) Patent Application Publication
(10) Pub. No.: US 2010/0055243 A1
(43) Pub. Date: Mar. 4, 2010

(54) METHOD FOR PRODUCING LOW-CAFFEINE TEA EXTRACT

(75) Inventor: Kenji Saito, Hiratsuka-shi (JP)

Correspondence Address: SUGHRUE MION, PLLC, 2100 PENNSYLVANIA AVENUE, N.W., SUITE 800, WASHINGTON, DC, 20037, US

(73) Assignee: Takasago International Corporation, Tokyo (JP)

(21) Appl. No.: 12/551,957

(22) Filed: Sep. 1, 2009

(30) Foreign Application Priority Data
Sep. 3, 2008 (JP) 2008-226241

(51) Int. Cl. A23F 3/38; A23F 3/40; A23F 3/16

(52) U.S. Cl. 426/52; 426/655; 426/597

(57) ABSTRACT

To provide a method for reducing a caffeine amount in a caffeine-containing tea extract liquid without deteriorating the original flavor of tea. The present invention provides a method for producing a low-caffeine tea extract, including the steps of: treating a caffeine-containing tea extract with tannase; causing a mixture of non-ester-type catechins and caffeine to be deposited in the caffeine-containing tea extract after the tannase treatment; and separating the deposited mixture for removal. Moreover, the present invention provides a low-caffeine tea extract obtained according to the production method and a food or drink containing the low-caffeine tea extract.

### BACKGROUND OF THE INVENTION

1. Field of the Invention

The present invention relates to a method for producing a tea extract having a reduced amount of caffeine without changing an original tea flavor.

2. Description of the Related Art

Absorption methods and the like are known as methods for removing caffeine from a tea extract (refer to Japanese Unexamined Patent Application Publication No. Hei 5-153910 and Japanese Patent Application Publication No. Hei 8-109178). Although caffeine is removed, these methods have a problem that the tea flavor is lost simultaneously with the removal of caffeine.

Meanwhile, the following decaffeination methods for coffee have been proposed: a method in which coffee is brought into contact with a caffeine absorbent such as activated carbon at a pressure of 120 to 250 atom (refer to Japanese Unexamined Patent Application Publication No. Sho 53-18772); and a method in which caffeine is selectively removed by bringing a caffeine-containing aqueous solution into contact with activated clay or acid clay (Japanese Unexamined Patent Application Publication No. Hei 6-142405). However, the former method relates to a supercritical extraction technique, and accordingly involves an excessively large equipment load for the process, thereby lacking simplicity when implemented at an industrial level. On the other hand, although capable of selectively removing caffeine by using only activated clay or acid clay, the latter method has a problem that the hue or the flavor of the aqueous solution may deteriorate.

### SUMMARY OF THE INVENTION

An object of the present invention is to provide a method for reducing a caffeine amount in a caffeine-containing tea extract liquid without deteriorating the original flavor of the tea.

The present inventors have found that caffeine is efficiently removed without considerably changing an original tea flavor by treating a caffeine-containing tea extract with tannase, causing a mixture of non-ester-type catechins and caffeine to be deposited, and separating the deposited mixture for removal.

Specifically, the present invention provides a method for producing a low-caffeine tea extract, the method comprising the steps of: treating a caffeine-containing extract tea with tannase; causing a mixture of non-ester-type catechins and caffeine to be deposited in the caffeine-containing tea extract after the tannase treatment; and separating the deposited mixture for removal.

In addition, the present invention provides a low-caffeine tea extract obtained by the above-described production method.

Further, the present invention provides a food or drink comprising the above-described low-caffeine tea extract.

Tannase is known to be usable for clarification of tea beverages. Tannase is an enzyme that acts on an ester bond between a catechin and gallic acid to hydrolyze to the catechin and gallic acid. Cream down (deposit formation) in a tea beverage is known to be caused by complex formation of ester-type catechins (having the same meaning as gallate-type catechins) with caffeine or the like. The tannase treatment prevents the formation of the complex with caffeine in a way that ester-type catechins are decomposed into non-ester-type catechins (having the same meaning as non-gallate-type catechins), making the formation of the complex less likely to occur (“Food processing and ingredients” 32(12), 1997, pp. 14 to 16).

As described above, the tannase treatment has been previously utilized for preventing the deposition by converting ester-type catechins into non-ester-type catechins to weaken the interaction between catechins and caffeine. However, the following caffeine-removing phenomenon utilizing the tannase treatment has not been known at all. Specifically, while the proportion of ester-type catechins among catechins is lowered with the tannase treatment, non-ester-type catechins and caffeine are bonded to each other and deposited, thereby allowing the caffeine to be removed efficiently.

According to the present invention, caffeine is removed from a caffeine-containing tea extract in a simple manner, without considerably changing the original tea flavor.

### DESCRIPTION OF THE PREFERRED EMBODIMENTS

The caffeine-containing tea extract used in the method for producing the low-caffeine tea extract of the present invention contains one or more kinds of non-polymer catechins. The term “non-polymer catechins” is a generic term that includes the following eight kinds of catechins: non-epicatechins such as catechin, gallocatechin, catechin gallate, and gallocatechin gallate; and epicatechins such as epicatechin, epigallocatechin, epicatechin gallate, and epigallocatechin gallate. In the present invention, the term “ester-type catechins” (having the same meaning as a gallate-type catechin) is a generic term that includes gallate ester-type catechins such as catechin gallate, gallocatechin gallate, epigallocatechin gallate, and epicatechin gallate of the aforementioned catechins.

In the present invention, the mass proportion (gallate percentage) of ester-type catechins in non-polymer catechins is a ratio of the sum of the masses of the aforementioned four kinds of ester-type catechins to the sum of the masses of the eight kinds of non-polymer catechins.

Examples of the caffeine-containing tea extract include extracts of tea leaves and concentrates thereof. Examples of the tea leaves include: green tea leaves being non-fermented teas such as SENCHA, BANCHA, GYOKURO, TENCHA and KAMAIRICHA, the green teas being produced from raw tea leaves obtained from the tea plant (scientific name: Camellia sinensis (L) O. Kuntze), which is an evergreen plant in the family Theaceae; tea leaves such as oolong tea, black tea, black-colored tea (post-heating fermented tea), and pu-erh tea which is produced from the above-described raw tea leaves through a semi-fermentation process or fermentation process. Preferably, a green tea leave is used. Examples of the extract of tea leaves include extracts which are obtained in such a way that: the above-described tea leaves are subjected to extraction by being stirred in water or a water-soluble organic solvent, for example, at 10 to 100° C., for 3 minutes to 6 hours or by column extraction therewith; and then the extract liquid is separated by employing appropriate separation means such as centrifugation. Examples of the concentrate of an extract of tea leaves include concentrates obtained by concentrating extracts of tea leaves by using an organic solvent, vacuum concentration, membrane concentration, or the like (for example, concentrates prepared by methods described in Japanese Unexamined Patent Application Publication Nos. Sho 59-219384, Hei 4-20589, Hei 5-260907, Hei 5-306279, or the like).

As the caffeine-containing tea extract in the present invention, one obtained by dissolving or diluting a concentrate of a tea extract in water may be used. Alternatively, a combination of an extract liquid of tea leaves and a concentrate of a tea extract may be used.

As the caffeine-containing tea extract, it is preferable to use a green tea extract having a non-polymer catechin content, in the solid component, of 20 to 90% by mass, particularly 20 to 70% by mass, further particularly 20 to 40% by mass, because taste components other than the non-polymer catechins remain therein. Here, the solid component is represented by the mass of a caffeine-containing tea extract obtained when the caffeine-containing tea extract is dried and solidified.

As the caffeine-containing tea extract, a commercially-available crude catechin product such as “POLYPHENON” (manufactured by Tokyo Food Techno Co., Ltd.), “TEAFURAN” (manufactured by ITO EN, LTD.), “SUNPHENON” (manufactured by Taiyo Kagaku Co., Ltd.), or the like also can be used.

The caffeine-containing tea extract may be enzymatically treated on or after the extraction to improve its flavor. For example, the caffeine-containing tea extract may be treated with protease or glutaminase in order to increase its umami, treated with α-amylase, glucoamylase or invertase in order to increase its sweetness, or treated with pectinase, protopectinase, xylanase, cellulase, hemicellulase, mannanase, lipase, or the like in order to improve the extraction efficiency.

In the method for producing the low-caffeine tea extract of the present invention, the above-described caffeine-containing tea extract is treated with tannase. Any kind of tannase can be used in the present invention, as long as the tannase has an activity to decompose gallate ester bonds in non-polymer catechins. For example, tannase obtained by culturing tannase-producing bacteria which belong to the genus Aspergillus, the genus Penicillium or the genus Rhizopus can be used. Of those, tannase from Aspergillus oryzae is particularly preferable.

The amount of tannase added to the caffeine-containing tea extract is approximately 0.01 to approximately 1.0 Unit, and preferably approximately 0.01 to approximately 0.1 Unit, per milligram of the non-polymer catechin content. Here, 1 Unit is defined as an enzyme amount capable of hydrolyzing 1 μmol of ester bonds in tannic acid in water at 30° C. per minute. As for a condition of the tannase treatment, it is appropriate to set the pH of an aqueous solution for the tannase treatment to 4.0 to 7.0, and preferably 4.5 to 6.0. As for the temperature in the tannase treatment, it is appropriate to perform the tannase treatment at 30 to 40° C., at which tannase exhibits the optimum enzyme activity thereof. The reaction time is not particularly limited. However, a high proportion of gallates is not preferable because the deposition speed of the mixture of non-ester-type catechins and caffeine becomes low. Accordingly, the reaction is continued until the gallate percentage reaches preferably 4% by mass or less, more preferably 3.5% by mass or less, and further preferably 2.5% by mass or less.

After the tannase treatment, the treated mixture may be concentrated in some cases. The concentration method is not particularly limited, and examples thereof include vacuum concentration, membrane concentration, freeze concentration, and the like.

In the method for producing the low-caffeine tea extract of the present invention, next, the mixture of non-ester-type catechins and caffeine is deposited in the caffeine-containing tea extract after the tannase treatment. The deposition of the mixture of non-ester-type catechins and caffeine is preferably performed at a low temperature with stirring. The deposition is performed within the temperature range from 0 to 25° C., and preferably from 0 to 15° C. The deposition is performed preferably for 1 to 43 hours, and more preferably 1 to 24 hours. The deposition may be accelerated by adding an extract in which the mixture has already been deposited, or by adding the deposition product, which is separated and purified, as core.

The deposited mixture of non-ester-type catechins and caffeine is then separated for removal by appropriate means such as filtration or centrifugation.

Before or after the above separation for removal, an alkali is added to adjust the pH to 4 to 7, and more preferably to 5.5 to 6.5. Examples of the alkali used here include sodium hydrogen carbonate, sodium carbonate, sodium hydroxide, and the like. The pH adjustment may be performed before the deposition step of the mixture.

After the separation for removal, the enzyme is inactivated. Note that the enzyme inactivation may be performed before the deposition step of the mixture. Although the enzyme inactivation may be performed by a pH adjustment or a heating treatment, in general, a heat-sterilization method is employed, which is performed at about 45 to 140° C. for 10 seconds to 30 minutes.

Although the obtained low-caffeine tea extract after the removal of the deposits can be added to a food or drink without further treatment because of its low bitterness and astringency, the obtained low-caffeine tea extract may be concentrated for use, by means such as vacuum distillation concentration, freeze concentration or membrane concentration. Further, the residual caffeine in the obtained low-caffeine tea extract may be removed by using activated carbon, acid clay, activated clay, a synthetic absorbent, or the like. By a purification treatment on the low-caffeine tea extract using a synthetic absorbent, a pure taste low-caffeine tea extract can be obtained from which unnecessary unpleasant taste components have been further removed. In addition, if desired, the low-caffeine tea extract may be converted into a powder form by drying the low-caffeine tea extract by employing appropriate drying means such as spray drying, vacuum drying, or freeze drying with or without addition of a vehicle such as dextrin, modified starch, cyclodextrin, or gum arabic.

Thus, the low-caffeine tea extract having a caffeine/non-polymer catechin mass ratio of 0 to 0.2 can be obtained.

Note that, to the low-caffeine tea extract of the present invention, various kinds of sub materials can be added as needed during the production processes or after the production processes. For example, cyclodextrin may be added as a bitterness or astringency inhibitor, and ascorbic acid may be added as an antioxidant.

The present invention makes it possible to provide foods or drinks, fragrances or cosmetics, hygienic, sanitary and medical products, and other products which contain low-caffeine tea extracts with less bitterness. Examples of these products include: beverages such as tea beverages, isotonic drinks, carbonated beverages, fruit juice drinks, dairy beverages and alcoholic beverages; frozen desserts such as ice creams, sorbet and ice lolly; pleasure products such as traditional Japanese confectionery, Western confectionery, chewing gum, chocolate, bread, coffee and black tea; various kinds of snacks; and the like.

### EXAMPLES

The present invention will be described in details below with reference to the following non-limiting Examples and Comparative Examples.

### Examples 1 to 4 and Comparative Examples 1 to 4

To determine an effective concentration of ester-type catechins for the removal of caffeine, the following operations were performed.

7.4 kg of green tea leaves produced by a steaming method were charged into a column. Ion-exchanged water at 70° C. was introduced to the column from the bottom thereof. The extract liquid was collected from the top of the column. Thus, 46 kg of an extract liquid having a Brix of 5.7% were obtained.

The extract liquid was filtered through a filter paper (manufactured by Advantec Toyo Kaisha, Ltd., No. 2), and then sterilized by being heated at 95° C. for 30 seconds. The sterilized extract liquid was concentrated with an RO membrane concentration system (manufactured by NITTO DENKO CORPORATION), and then sterilized by being heated at 95° C. for 30 seconds. Thus, a green tea extract A having a Brix of 10% and a pH of 5.9 was obtained.

To the green tea extract, 0.003% by mass (0.062 Unit) of tannase FKT50 (manufactured by Kikkoman Corporation, Industrial Grade, 50, 000 U/g or more) relative to the amount of the liquid was added. Reaction was allowed to proceed at 30° C. until the concentration of ester-type catechins reached the detection limit or below. After the reaction, the pH was adjusted to 6.0 by using sodium hydrogencarbonate, and the mixture was heated at 80° C. for 10 minutes for inactivation of the enzyme.

Green tea extracts having targeted ester-type catechin proportions were prepared by mixing this green tea extract B subjected to the tannase treatment and the green tea extract A not subjected to the tannase treatment in ratios shown in Tables 1 and 2.

Next, these green tea extracts were stirred at 4° C. for 20 hours, and the generated deposit of the catechins and caffeine was removed by centrifugation. The resultant green tea extracts were sterilized by being heated at 80° C. for 10 minutes. The caffeine concentration of each of the obtained green tea extracts was determined by HPLC.

### <HPLC Determination Conditions>

### Sample Preparation Method

Each green tea extract was diluted 20 times with purified water, filtered through a 0.45-μm membrane filter (ADVANTEC). Thereafter, determination was performed under the following conditions:
System: Agilent 1100 Series (Agilent Technologies, Inc.)
Mobile phase: Eluent A, 0.05% by volume phosphoric acid aqueous solution; Eluent B, methanol
Column: Inertsil ODS-3 (5 μm, 4.6 mm×150 mm) (GL Sciences Inc.)
Flow rate: 0.8 ml/min
Gradient: Eluents were flowed such that A/B was kept at 80/20 for 15 minutes from the start, changed to 75/25 over 10 minutes, then to 60/40 over 5 minutes, and kept at 60/40 for 20 minutes.

### [Table 1]

TABLE 1

| | Example 1 | Example 2 | Example 3 | Example 4 |
|---|---|---|---|---|
| Green tea extract A | — | 1.9 | 3.8 | 5.7 |
| (% by mass) | | | | |
| Green tea extract B | 100.0 | 98.1 | 96.2 | 94.3 |
| (% by mass) | | | | |

Before stirring with cooling

| | | | | |
|---|---|---|---|---|
| Non-polymer catechins | 1.96 | 1.97 | 1.98 | 1.99 |
| (% by mass) | | | | |
| Ester-type catechins | ND | 0.02 | 0.04 | 0.06 |
| (% by mass) | | | | |
| Non-ester-type catechins | 1.96 | 1.95 | 1.94 | 1.92 |
| (% by mass) | | | | |
| Proportion of ester-type | 0.0 | 1.1 | 2.2 | 3.3 |
| catechins in non-polymer | | | | |
| catechins (% by mass) | | | | |
| Caffeine (% by mass) | 0.64 | 0.64 | 0.64 | 0.66 |
| Brix (%) | 10.0 | 10.0 | 10.0 | 10.0 |
| Content of non-polymer | 24.2 | 24.2 | 24.2 | 24.2 |
| catechins in solid | | | | |
| components (% by mass) | | | | |

After treatment

| | | | | |
|---|---|---|---|---|
| Non-polymer catechins | 0.97 | 0.99 | 1.07 | 1.16 |
| (% by mass) | | | | |
| Ester-type catechins | ND | 0.01 | 0.01 | 0.05 |
| (% by mass) | | | | |
| Non-ester-type catechins | 0.97 | 0.99 | 1.06 | 1.11 |
| (% by mass) | | | | |
| Proportion of ester-type | 0.0 | 0.7 | 1.1 | 4.4 |
| catechins in non-polymer | | | | |
| catechins (% by mass) | | | | |
| Caffeine (% by mass) | 0.13 | 0.13 | 0.14 | 0.19 |
| Brix (%) | 7.9 | 7.9 | 7.9 | 7.9 |
| Caffeine/non-polymer | 0.13 | 0.13 | 0.13 | 0.16 |
| catechins (mass ratio) | | | | |
| Caffeine residual ratio | 19.8 | 19.7 | 22.3 | 29.1 |
| (% by mass) | | | | |

*ND: not detected

### [Table 2]

TABLE 2

| | Compar- | Compar- | Compar- | Compar- |
|---|---|---|---|---|
| | ative | ative | ative | ative |
| | Example 1 | Example 2 | Example 3 | Example 4 |
| Green tea extract A | 7.6 | 9.5 | 19.3 | 100.0 |
| (% by mass) | | | | |
| Green tea extract B | 92.4 | 90.5 | 80.7 | — |
| (% by mass) | | | | |

Before stirring with cooling

| | | | | |
|---|---|---|---|---|
| Non-polymer catechins | 2.00 | 2.01 | 2.05 | 2.42 |
| (% by mass) | | | | |
| Ester-type catechins | 0.09 | 0.11 | 0.22 | 1.16 |
| (% by mass) | | | | |
| Non-ester-type catechins | 1.91 | 1.90 | 1.83 | 1.26 |
| (% by mass) | | | | |
| Proportion of ester-type | 4.3 | 5.5 | 10.9 | 48.0 |
| catechins in non-polymer | | | | |
| catechins (% by mass) | | | | |
| Caffeine (% by mass) | 0.65 | 0.64 | 0.64 | 0.66 |
| Brix (%) | 10.0 | 10.0 | 10.0 | 10.0 |
| Content of non-polymer | 24.2 | 24.2 | 24.2 | 24.2 |
| catechins in solid | | | | |
| components (% by mass) | | | | |

After treatment

| | | | | |
|---|---|---|---|---|
| Non-polymer catechins | 1.83 | 1.88 | 1.96 | 1.84 |
| (% by mass) | | | | |
| Ester-type catechins | 0.10 | 0.09 | 0.20 | 0.72 |
| (% by mass) | | | | |
| Non-ester-type catechins | 1.74 | 1.78 | 1.76 | 1.12 |
| (% by mass) | | | | |
| Proportion of ester-type | 5.2 | 4.8 | 10.0 | 39.3 |
| catechins in non-polymer | | | | |
| catechins (% by mass) | | | | |
| Caffeine (% by mass) | 0.57 | 0.64 | 0.64 | 0.43 |
| Brix (%) | 9.2 | 9.8 | 9.8 | 8.2 |
| Caffeine/non-polymer | 0.31 | 0.34 | 0.33 | 0.23 |
| catechins (mass ratio) | | | | |
| Caffeine residual ratio | 87.2 | 98.9 | 100.0 | 65.5 |
| (% by mass) | | | | |

As seen from the results, it is proved that caffeine can be removed efficiently by, after the tannase treatment, performing stirring at a low temperature to deposit caffeine and catechins. In this treatment, the lower the concentration of ester-type catechins is, the higher the efficiency becomes. In Comparative Example 1 where no tannase treatment was performed, although the Brix decreased by a relatively high extent after the treatment, a large amount of caffeine remained, and therefore other components important for taste seem to be removed.

Next, conventional caffeine-removing techniques and the present invention were compared with each other.

### Example 5

6.0 kg of green tea leaves produced by a steaming method was charged into a column. Ion-exchanged water at 70° C. was introduced to the column from the bottom thereof. The extract liquid was collected from the top of the column. Thus, 36 kg of an extract liquid having a Brix of 5.0% were obtained.

The extract liquid was filtered through a filter paper (manufactured by Advantec Toyo Kaisha, Ltd., No. 2), and then sterilized by being heated at 95° C. for 30 seconds.

The sterilized extract liquid was concentrated with an RO membrane concentration system (manufactured by NITTO DENKO CORPORATION), and then sterilized by being heated at 95° C. for 30 seconds. Thus, a green tea extract C having a Brix of 12.3% and a pH of 6.0 was obtained (the content of non-polymer catechins in the solid component was 24.3% by mass).

To 5 kg of the green tea extract C, 0.003% by mass (0.050 Unit) of tannase FKT50 (manufactured by Kikkoman Corporation, Industrial Grade, 50,000 U/g or more) relative to the amount of the liquid was added. Reaction was allowed to proceed with stirring at 30° C. for 1 hour. The pH of this liquid after the tannase reaction was adjusted to 6.0 by using sodium hydrogencarbonate, and the liquid was stirred at 15° C. for 14 hours. The deposited insoluble products of caffeine and non-gallate catechins were removed by centrifugation. After the centrifugation, the liquid was sterilized by being heated at 95° C. for 30 seconds.

### Comparative Example 5

A green tea extract was obtained by the same treatments as those in Example 5 except that no tannase was added.

### Comparative Example 6

To 5 kg of the green tea extract C, one kilogram of activated carbon (pelletized Shirasagi manufactured by Japan EnviroChemicals, Ltd.) was added. The mixture was held at 40° C. for 30 minutes with occasional stirring, and then centrifugated. Next, the green tea extract was sterilized by being heated at 95° C. for 30 seconds.

### Comparative Example 7

To 5 kg of the green tea extract C, one kilogram of activated clay (manufactured by NACALAI TESQUE, INC.) was added. The mixture was held at 40° C. for 30 minutes with occasional stirring, and then centrifugated. The pH was adjusted to 6.0 by sodium hydrogencarbonate, and then the green tea extract was sterilized by being heated at 95° C. for 30 seconds.

### [Table 3]

TABLE 3

| | Green | | | | |
|---|---|---|---|---|---|
| | tea | | Comparative | Comparative | Comparative |
| | extract C | Example 5 | Example 5 | Example 6 | Example 7 |
| Non-polymer catechins | 2.99 | 1.21 | 2.37 | 2.24 | 2.63 |
| (% by mass) | | | | | |
| Ester-type catechins | 1.47 | ND | 1.00 | 1.19 | 1.23 |
| (% by mass) | | | | | |
| Non-ester-type catechins | 1.52 | 1.21 | 1.37 | 1.05 | 1.40 |
| (% by mass) | | | | | |
| Proportion of ester-type | 49.3 | 0.0 | 42.3 | 53.1 | 46.9 |
| catechins in non-polymer | | | | | |
| catechins (% by mass) | | | | | |
| Caffeine (% by mass) | 0.82 | 0.09 | 0.56 | 0.41 | 0.29 |
| Brix (%) | 12.3 | 9.9 | 10.7 | 10.4 | 10.7 |
| Caffeine/non-polymer | 0.27 | 0.07 | 0.24 | 0.18 | 0.11 |
| catechins (mass ratio) | | | | | |
| Caffeine residual ratio | 1.5 | 0.2 | 1.1 | 0.8 | 0.5 |
| (% by mass) | | | | | |

### <Sensory Evaluation>

The flavors of the green tea extracts obtained in Example 5 and Comparative Examples 6 and 7 were compared with one another. Each of the extracts was diluted to have a Brix of 0.3%, and rated by five well-trained panelists in terms of odor, bitterness and taste on a five-point scale with the green tea extract C being rated as 3. The average points are shown in Table 4. The criteria are as follows:
Odor: 5 very strong, 4 strong, 3 medium, 2 weak, and 1 very weak
Bitterness: 5 very strong, 4 strong, 3 medium, 2 weak, and 1 very weak
Taste: 5 very good, 4 good, 3 medium, 2 bad, and 1 very bad

### [Table 4]

TABLE 4

| | Odor | Bitterness | Taste | Comment |
|---|---|---|---|---|
| Green tea extract C | 3 | 3 | 3 | |
| Example 5 | 3.4 | 1.6 | 3.4 | Good to drink |
| Comparative Example 6 | 2.6 | 3 | 2 | Weak odor |
| Comparative Example 7 | 3 | 3.6 | 1.8 | Astringent, |
| | | | | irritating, malodor |

As shown in the results in Table 4, Example 5 that corresponds to the present invention was evaluated as being good in odor, low in bitterness and good in taste.

What is claimed is:

1. A method for producing a low-caffeine tea extract, comprising the steps of:
treating a caffeine-containing tea extract with tannase;
causing a mixture of non-ester-type catechins and caffeine to be deposited in the caffeine-containing tea extract after the tannase treatment; and
separating the deposited mixture for removal.

2. The method for producing the low-caffeine tea extract according to claim 1, wherein a proportion (gallate percentage) of ester-type catechins in non-polymer catechins after the tannase treatment is 4% by mass or less.

3. The method for producing the low-caffeine tea extract according to claim 1, wherein a mass ratio of caffeine to the non-polymer catechins in the low-caffeine tea extract is 0 to 0.2.

4. The method for producing the low-caffeine tea extract according to claim 1, wherein the mixture of the non-ester-type catechins and the caffeine is deposited by cooling under conditions of a temperature range from 0 to 25° C. and a time range from 1 to 43 hours.

5. The method for producing the low-caffeine tea extract according to claim 1, wherein the tannase treatment is performed under a condition of a temperature range from 30 to 40° C.

6. The method for producing the low-caffeine tea extract according to claim 1, which is extracted from green tea.

7. A low-caffeine tea extract obtained by the production method according to claim 1.

8. A food or drink comprising the low-caffeine tea extract according to claim 7.
